(19) United States
(12) Patent Application Publication
(10) Pub. No.: US 2003/0223554 A1
(43) Pub. Date: Dec. 4, 2003

(54) Communication systems and methods

(76) Inventor: Jack K. Zhang, Ijamsville, MD (US)

Correspondence Address: Law Office of Jerome D Jackson, Suite 100, 211 N Union Street, Alexandria, VA, 22314, US

(21) Appl. No.: 10/257,437

(22) PCT Filed: Mar. 6, 2001
(86) PCT No.: PCT/US01/07036

(51) Int. Cl. H04M 11/00; H04M 15/00; G06F 17/00

(52) U.S. Cl. 379/93.12; 379/114.13; 379/93.24; 705/500

(57) ABSTRACT

It is an object of the present invention to provide an efficient system for communicating with a broadcast audience. To achieve this and other objects of the present invention, there is a method for a system having a transmitter (811) that broadcasts a first signal (450). The method comprises receiving the first signal (450); decoding (810) the first signal into the second signal (659), the second signal being human perceptible; decoding the first signal into the third signal (660), the third signal being digital; receiving an input from a user (712), after the decoding steps (802); generating the fourth signal (806), responsive to the input (712); generating a fifth signal (750) by appending the fourth signal (806) to the third signal (660); and sending the fifth signal (750).

This Application claims the benefit of Application Serial No. 60/187,514 of JACK K. ZHANG filed Mar. 7, 2000 for APPARATUS AND METHOD FOR WIRELESS INSTANT MESSAGING IN RESPONSE TO RADIO OR TV BROADCASTING IN OTHER ELECTRONIC MEDIA SESSION, the contents of which are herein incorporated by reference.

### BACKGROUND OF THE INVENTION

1. Field of the Invention

This invention relates generally to commercial systems and, more particularly, to systems and methods that allow broadcast audience members to compile and transmit respective messages in response to the broadcast.

2. Description of Related Art

Issues affecting a broadcaster and advertisers include a constant interest in knowing about broadcast audience members, and getting interested members to respond anytime, anywhere, and quickly. Proposed methods to address these issues include voice calling, sending a hardcopy letter, sending a fax, sending electronic mail (email), or using a Mobile Track service. These proposed methods have shortcomings, however. For example, there are situations, such as driving a car or doing certain household chores, that do not permit an audience member to respond promptly to a broadcast. Subsequently, the audience member may likely forget important details about what might have interested him in the broadcast, contact information to respond, or to request for more detailed information after a substantial time lapse after the broadcast. Such delay prevents the instantaneous nature of broadcasting to be fully utilized.

### SUMMARY OF THE INVENTION

It is an object of the present invention to provide an efficient system for communicating with a broadcast audience.

To achieve this and other objects of the present invention, there is a method for a system having a transmitter that broadcasts a first signal. The method comprises receiving the first signal; decoding the first signal into a second signal, the second signal being human perceptible; decoding the first signal into a third signal, the third signal being digital; receiving an input from a user, after the decoding steps; generating a fourth signal, responsive to the input; generating a fifth signal by appending the fourth signal to the third signal; and sending the fifth signal.

### BRIEF DESCRIPTION OF THE DRAWINGS

FIG. 1 is a diagram showing an electronic device in accordance with a first preferred embodiment of the present invention.

FIG. 2 is a diagram showing use of wireless handheld devices with automated response enabling functions of preferred embodiments of the present invention, connecting to a Web-based information system for broadcasting and response applications (WISBRA) (illustrated only using radio broadcasting.

FIG. 3 is a diagram showing electronic media terminals and wireless handheld device in accordance with preferred embodiments of the present invention.

FIG. 4 is a diagram showing generation of content and UMCID in commercial broadcasting.

FIG. 5 is a diagram showing signal processing in electronic media of preferred embodiments of the present invention for communication with handheld devices.

FIG. 6 is a diagram showing signal processing in one preferred embodiment handheld device of preferred embodiments of the present invention for communication with WISBRA via wireless network.

FIG. 7 is a diagram of example procedures for automatically processing response message from handheld devices of preferred embodiments of the present invention.

FIG. 8 is a diagram of signal processing in first preferred embodiment handheld device of preferred embodiments of the present invention for communication with WISRA via wireless network.

FIG. 9 is a diagram showing logic for single-button listener response to radio and other broadcasting.

FIG. 10 is a diagram showing logic for multiple-button listener response to radio and other broadcasting.

The accompanying drawings, which are incorporated in and which constitute a part of this specification, illustrate embodiments of the invention. Throughout the drawings, corresponding parts are labeled with corresponding reference numbers.

### DESCRIPTION OF THE PREFERRED EMBODIMENTS

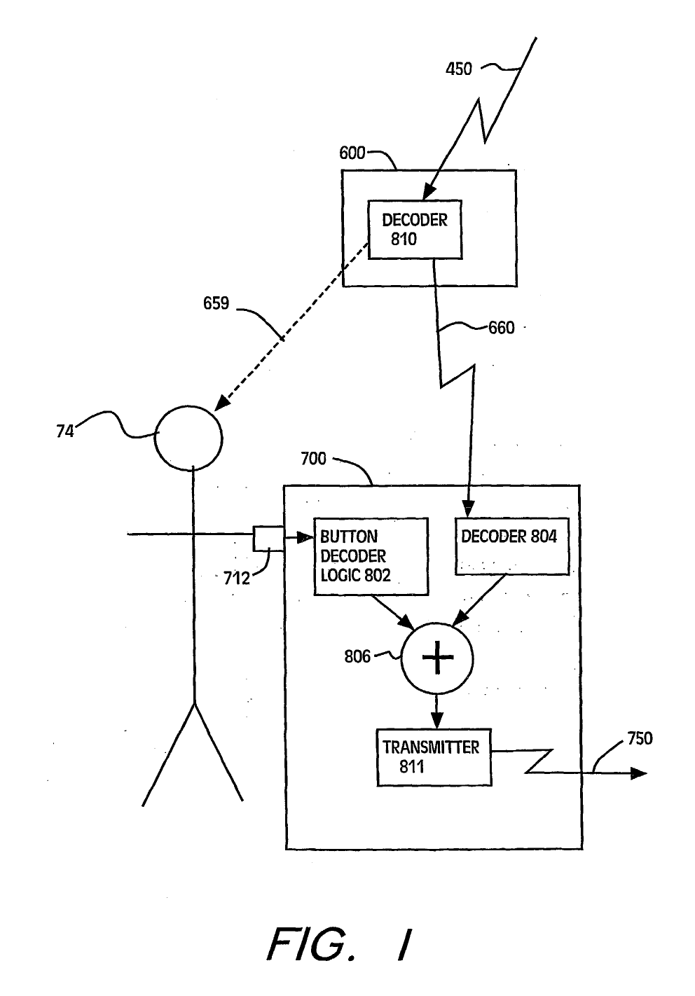

FIG. 1 shows a device 700 carried by a member 74 of a broadcast audience, in accordance with a first preferred embodiment of the present invention. Device 700 includes a button 712 on an exterior housing of device 700. Button decode logic 802, inside the housing of device 700, receives an on or off signal from button 712 and, responsive to activation of button 712 and the length of activation of button 712, generates a multi-valued code and sends the code to signal combiner 806. Device 700 receives a signal 660, generated by terminal 600, in response to receiving a broadcast signal 450. Decoder in device 804 extracts a digital code from signal 660 and sends the code to signal combiner 806. Transmitter 811 receives a signal from signal combiner 806 and transmits the combined signal over signal path 750.

Of course, FIG. 1 shows device 700 with a greatly exaggerated physical size, to allow certain structure in device 700 to be shown in FIG. 1. Preferably, device 700 is a small housing that can be carried by the user or worn on the user's belt.

Decoder 810 receives broadcast signal 450 and, responsive to signal 450, demodulates a component of signal 450 to produce a human perceptible signal 659. When device 600 is a radio, this human perceptible signal is a sound wave. In the case of device 600′, described below, the human perceptible signal also includes a light signal perceived by user 74.

Decoder 810 also generates a signal 660, described in more detail below, and sends the signal 660 to portable device 700.

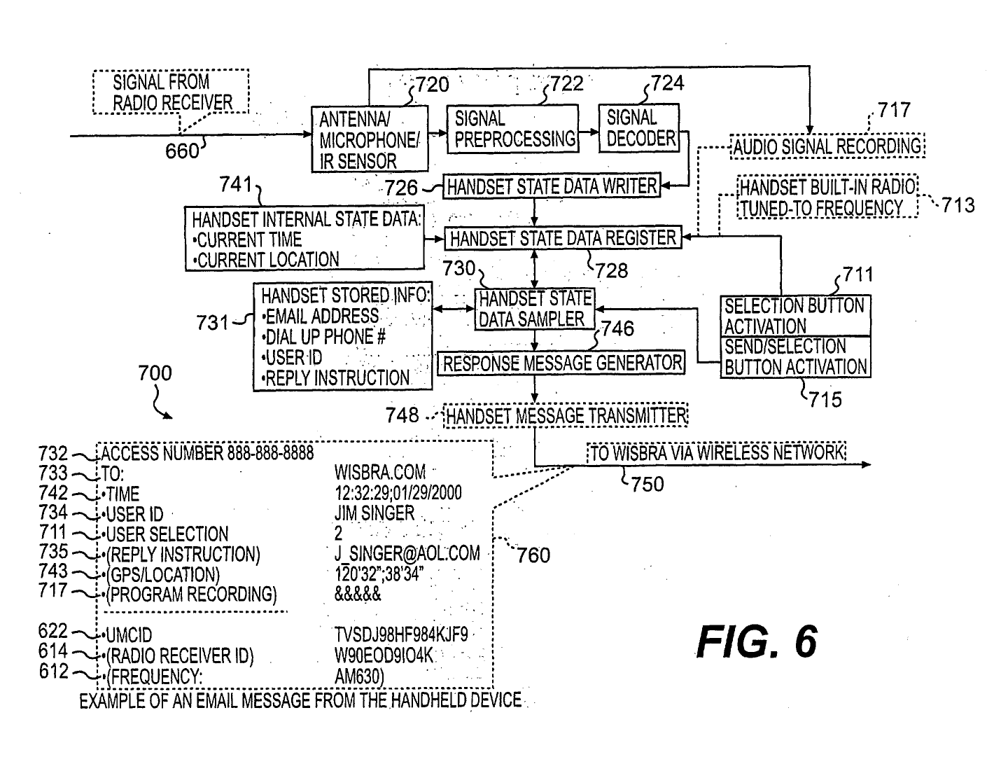

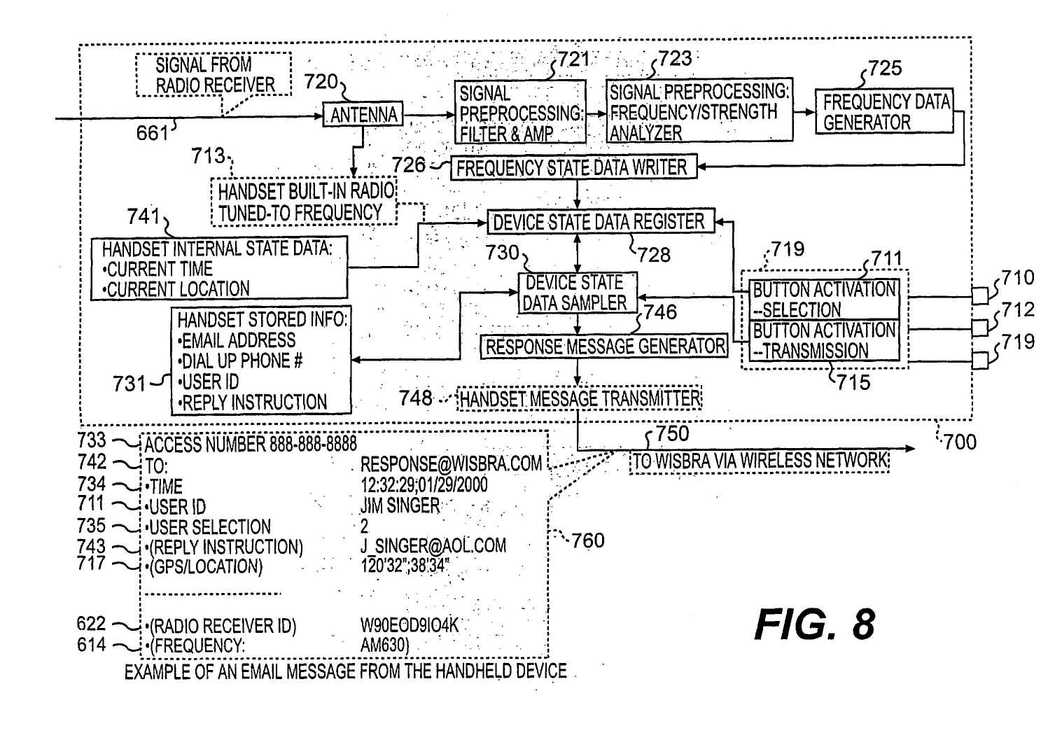

Decoder 810 includes modules 620, 630, 632, 634, 636, 638, 640, and 622 described below. Decoder 802 includes modules 711 and 715. Decoder 804 includes: modules 720, 722, 724, 726, 728 described below in FIG. 6; or modules 720, 721, 723, 725, 726, 728 described below in FIG. 8. Module 806 includes modules 730, 746, shared modules 741, 731. Module 810 includes module 748 described below.

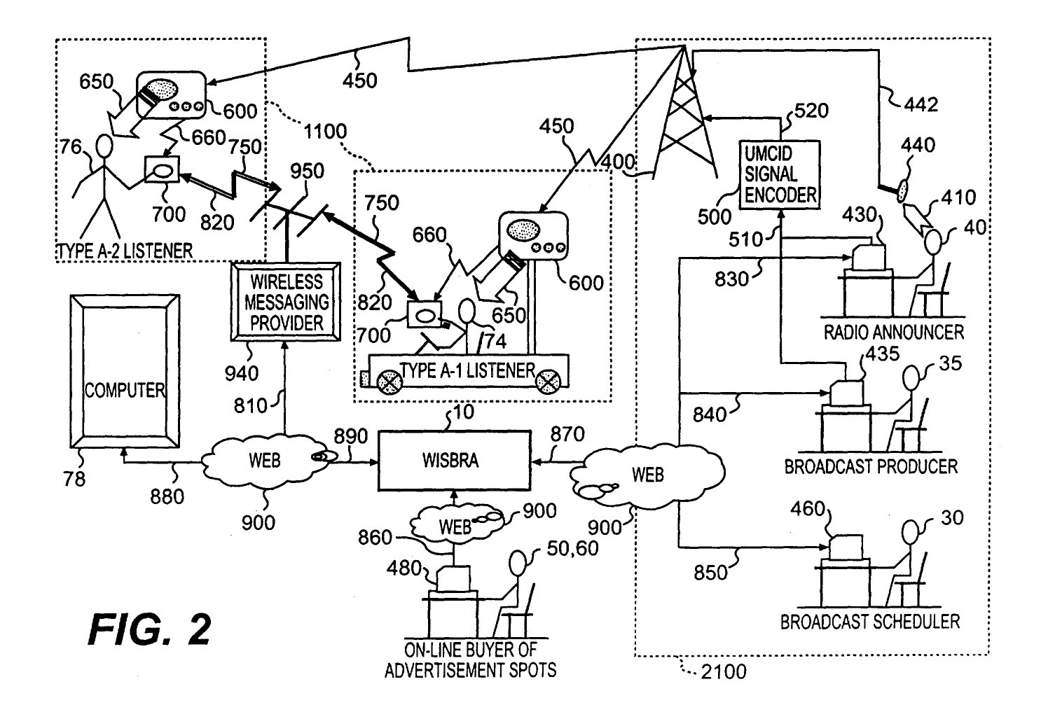

FIG. 2 shows a system 2000 in accordance with a first preferred embodiment of the present invention. An object of system 2000 is the provision of a convenient method for TV, radio, or other electronic media audience to individually respond instantly to a program through a handheld device with one single action—pressing a button.

Another objective of system 2000 is the provision of a system and apparatus for a person to easily respond to a media session through any electronic media he/she is exposed to anywhere, anytime.

Yet another object of system 2000 is the provision of a method and system for all electronic media content to be universally identifiable so that audience can easily find the information related to a media session. This also provides valuable information for broadcasting or media companies to monitor their own performance and for manufacturers of electronics to see the use of their particular product.

System 2000 relates to a method, apparatus and system for instantly collecting, distributing and processing audience responses to a broadcast session. System 2000 includes an operating electronic media terminal (radio, TV, CD player, computer, etc.) equipped with an apparatus for receiving, decoding and re-transmitting broadcast content identification information; an apparatus (typically a wireless handheld device) for receiving, decoding and storing the identification information from any one of the electronic media terminals; an interface in the apparatus that can be actuated by a user with one single action; a processor in the apparatus enabling, upon the actuation action from the user, automatic data collection, sampling, compiling and transmitting messages to a response processing center via a public network; and a processing center comprising hardware and software for processing such responses.

System 2000 includes a computer system 10, broadcast facilities 2100, internet web 900, general computer 78, wireless messaging service provider 940, an electronic media terminal (radio, TV, CD/DVD/tape player or computer, etc.) 600, and a wearable wireless device (pager, cell phone, computers, etc) 700.

Computer system 10 is disclosed in detail in Provisional Application No. 60/168,070, the contents of which are herein incorporated by reference. In system 2000, system 10 serves as Web-based Information System for Broadcast Response Applications (WISBRA). Though bearing different name and slight variations in the description for clarity purpose, it is intended to refer to the same general computer system serving electronic media broadcasting, including scheduling, content storage, and all information processing.

Broadcast facility 2100 includes announcer application computer 430, producer application computer 435, broadcast program scheduler computer 460, transmission equipment 400, connections to the Internet web 830, 840, 850 and 870, and a signal converting UMCID encoder 500. Computers 430,435 and 460 are application computers in the sense that they respectively serve as browser interfaces of applications software for a broadcasting function. All the interfaces can reside on the same physical computer or accessible simultaneously via any computer of common browsers, such as Internet Explorer™, Netscape™, etc.

The on-line buyer's computer 480, similar to computer 460, is also an application computer in this sense.

General computer 78, with email capability, is one designated by broadcast audience members 74 or 76 to receive information.

All the computers described above are connected to the Internet web 900 via DSL or other methods known in the art. The preferred method for computers 430 and 435 are high speed connections such as cable, DSL or Ti for constant-on features. Computers 460 and 480 can be connected to the web through any popular connection methods.

Wireless messaging service provider 940, capable of sending and receiving email from the internet, represents any of the terrestrial or satellite alpha-numeric paging providers, wireless internet service providers or any other forms of wireless messaging service. Any wired connection serving such purpose of transmitting and receiving messages is an alternative.

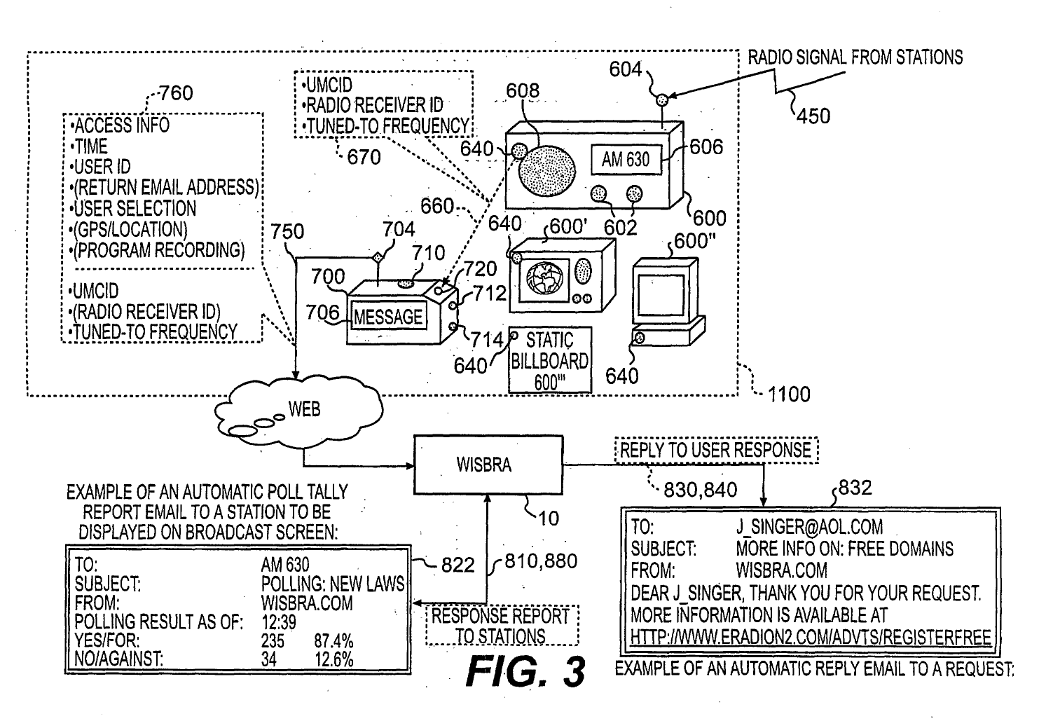

FIG. 3 emphasizes subsystem 1100 of system 2000. Subsystem 1100 comprises an electronic media terminal (radio, TV, computer, etc.) 600 and a wearable wireless device (pager, cell phone, computers, etc) 700.

Electronic media terminal 600 is any unit of radio receiver, TV set, computer, CD player, cassette player or digital format MP3 player on which an electronic media session can be performed to an audience of one or multiple individuals. Terminal 600, illustrated using a radio receiver with dial 602, antenna 604, display 606 and speaker 608 with all the well-known features and functions found in a radio, receives radio broadcast signal 450. Broadcast signal 450 can be any electromagnetic signal-carrying analog or digital signals from land based tower or satellite remote to terminal 600. Terminal 600 includes circuitry to extract information from radio signal 450, generate and transmit a new signal 660 different from 450, containing all or partial information in digital packet 670, through transducer 640 in media that is imperceptible to humans. In this Patent Application, the word circuitry encompasses dedicated hardware, and/or programmable hardware; such as a CPU or reconfigurable logic array, in combination with programming data, such as sequentially fetched CPU instructions or programming data for a reconfigurable array.

Terminal 600′ is a television set including circuitry that may receive a broadcast signal, generates signal 660 for reception by device 700, and generates a human perceptible signal 659 including a light signal and a sound wave.

Terminal 600″ is a computer that may receive a broadcast signal and generate signal 660 for reception by terminal 700 and a human perceptible light signal.

Terminal 600′″ is a static billboard in a public place, such as an airport for example.

Terminal 600′″ receives no broadcast signal, but generates signal 660 for reception by device 700. Static billboard 600′″ may be a static film lighted from an opposite side of the viewing side. In other words, static billboard 600′″ may be a panel that sends a human perceptible eight signal to a viewer by transmitting a light signal through the panel. Alternately, static billboard 600′″ may be a reflective panel that merely reflects ambient light, allowing the user to view the contents of billboard 600′″.

Transducer 640 is one or more energy transducers that can convert one form of energy, such as electricity, to an electromagnetic wave, ultrasound, or Infrared light, for example. Therefore, transducer 640 can be one or a combination of such transducers. The typical transmission from transducer 640 is very short range by design, while fully satisfying application needs, minimizing interference and maximizing the accuracy of identification.

Wearable wireless device 700 includes one of any type of two-way pager, cell phone, PSA, PCS, Laptop, or other device capable of sending a wireless message, such as a wireless email message. Offering all common functions in the type of wireless device and using a pager for illustration only, Device 700 includes electronics not shown, a message display 706, and an antenna 704. Device 700 includes a transducer 720 for receiving signals from transducer 640 in 600, activation buttons 710, 712 and 714, located on the device 700 such that fingers in one hand can conveniently press any button to initiate and send a message from 700, to request more information or simultaneously activate one or more buttons to express selections in the options given in a media session, an opinion poll for example. Since the device 700 includes circuitry to automatically collect media session information, generate a message with necessary information, send the message to WISBRA 10, which processes requests from device 700, the whole process is transparent to a user of device 700. The user need merely press the appropriate button(s) 710, 712, or 714, to complete an information request in a single action. The single action can be, in addition to pressing buttons, sliding of buttons, actuating knobs, etc., depending on the actual design of device 700.

Terminal 600 may generate the tuned-to-frequency component of signal 670 locally, or terminal 600 may extract the tuned-to-frequency component from broadcast signal 450.

Device 700 generates signal 760 by combining an output of button decoder logic 802 with components from signal 660. In signal 760, access information may include an email address, a telephone number, or a combination of such information. Time is a timestamp generated by device 700. The user id may be an id for identifying the holder of device 700. User id may be a telephone number, for example. In signal 760, items in parenthesis are optimizations.

In signal 760, user selection is the code generated by button decoder 802.

In signal 760, program recording is a five second recording of the entire broadcast signal 450, in cases where a UMCID is not supplied to device 700, the system may nevertheless be able to identify the broadcast signal with this five second recording.

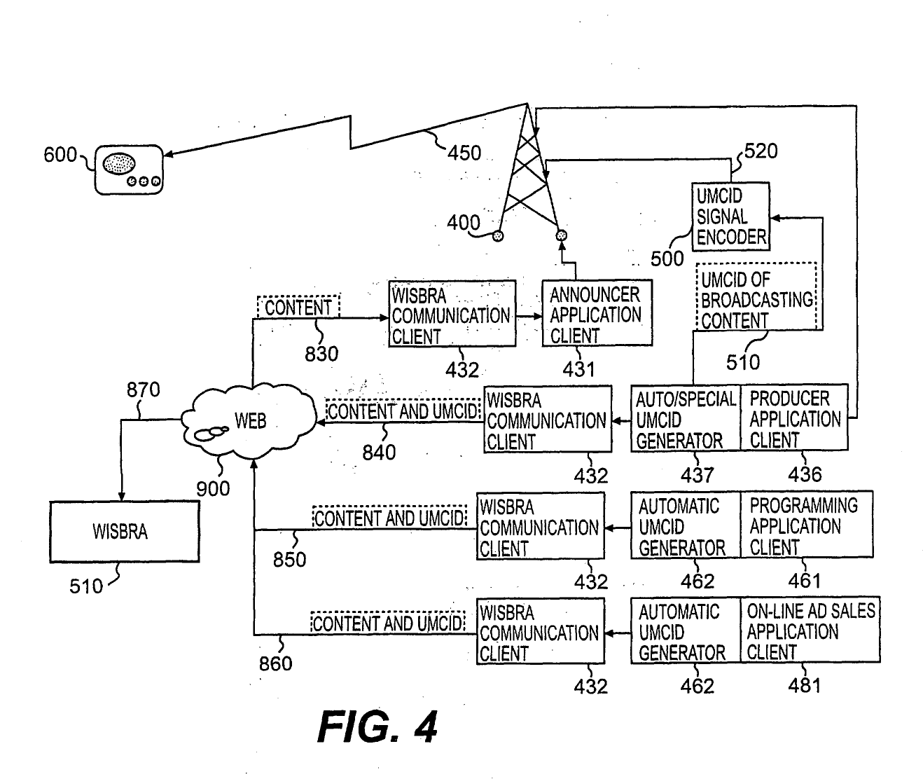

Referring to FIG. 2 and FIG. 4, broadcast scheduler 30 and advertisement on-line buyers 50, 60 input broadcast content and programming time spots information via computers 460 and 480, respectively, into WISBRA 10. The content can be advertisement script, recording, or other materials. Responsive to an advertisement session being entered through 418, the Unified Media Content Identification (hereafter, UMCID) generator 462 assigns a unique code and attaches the code to advertisement content before uploading the entry through web communication client 432 to WISBRA 10.

A typical UMCID contains at least 4 segments of information: a segment to identify the content originator, in this case advertisement end buyer; a segment to identify the agency representing the ad buyer; a segment to identify the broadcasting network; and a segment to identify the station/channel from which the audience actually receives the broadcast. The UMCID protocol enables terminals 600 to transmit information in a common format, allowing any device 700 in the vicinity to receive, recognize and understand the information.

Thus, for example, allowing two people in the same car, each having a device 700, to individually respond to broadcast segments of interest to each one from the same radio receiver. Furthermore, a single person, using the same device 700, may respond to a radio broadcast segment in the car when he is driving, then to a TV news broadcast when he gets home, and later to a movie from a DVD player.

Thus, system 2000 enables audience members to respond to a media session easily and conveniently, anywhere, anytime and to any media presented through a terminal 600.

Producer 35 will direct and produce the actual broadcast session partially from the content in existence in WISBRA 10 accessible through application computer 435. When a pre-recorded advertisement is played, that recording will carry first two sections of UMCID: Advertiser and agency.

When a song is played, producer application client 436 will, through hardwired or wireless connection 442, give command to activate the broadcast equipment 400 to transmit the signal carrying the song. The song recording will carry first two sections of UMCID: Song/singer and publisher. When the advertisement is to be read by the announcer 40, the auto/special UMCID generator 437 in producer application client 436 will generate a UMCID consisting all four sections if UMCID is detected missing.

When a polling question is aired, the producer will manually assign a “Polling” UMCID through 437. Such UMCID will have a question serial number stored in WISBRA 10 in the first section and station or network ID in the second section. When an action is aired, the producer will manually assign an “Auction” UMCID through 437. Auction UMCID will have the serial number an article description stored in WISBRA 10 in the first section and auctioneer's ID in the second section. The UMCID generators 462 and 437 will add the last two sections representing network affiliation and station/channel ID.

Each time when a program is broadcast, via connection 510, the UMCID information is automatically sent to UMCID signal encoder 500 to be prepared for transmission with broadcast signal.

The UMCID is present in recordings as a beacon. As a result the UMCID will be present, for example, at the beginning of the song recording, and is rebroadcast, by encoder 500, every 20 seconds. Because the UMCIDs can be data-economical, the signal carrying the UMCIDs requires very little bandwidth.

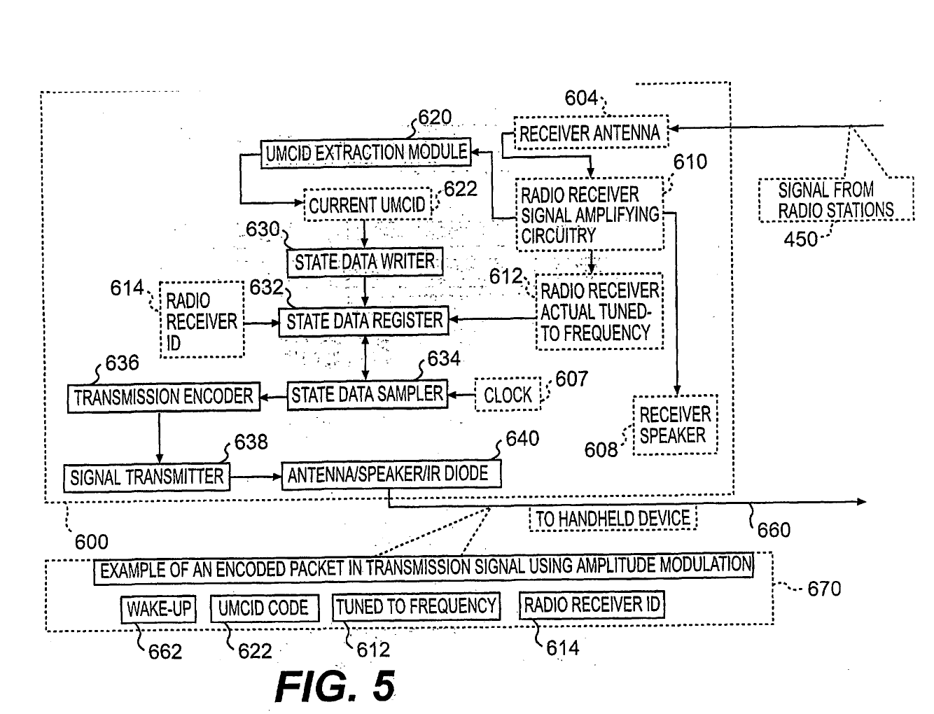

FIG. 5 shows how a broadcast signal 450 is processed by terminal 600 to generate identification signal 660 for reception by device 700. Through antenna 604, signal 450 is processed by radio receiver signal amplifying circuitry 610 to produce an audio signal for speaker 608. This audio signal is a type of human perceptible signal.

The pass through or preprocessed signal from 450 is sent to UMCID Extraction Module 620. Module 620 extracts the current UMCID 622 of the content in broadcasting, and sends UMCID 622 to state data writer 630, causing writer 630 to send data into state data register 632.

Data register 632 is a data holding center, responsible for keeping UMCID, radio receiver actual tuned-to frequency 612, mostly available from the amplification circuitry 610, and radio receiver identification number 614, number 614 is stored in the receiver by the manufacturer.

Register 632 keeps as much state-change history as practical. As receiver ID 614 is typically a constant and frequency data 612 is less changeable as UMCID, the primary function of register 632 is to keep UMCID history.

There are several conditions that cause state data sampler 634 to fetch data from register 632 to initiate a data transmission 660. When data register 632 has a state change, either as a result of UMCID 622 update or the listener (in the case of radio) changes station resulting new frequency data 612, it will send a trigger to data sampler 634, informing sampler 634 to fetch data from register 632. When there is no change to register 632, a clock 607 will periodically prompt data sampler 634 to fetch data from register 632. Each time the data is obtained by 634, they are forwarded to encoder 636 to assemble into desired format, then to signal transmitter 638 and further to antenna/speaker/IR diode 640 transmitted into signal 660.

Although terminal 600 uses ultrasound, the combination of all three transmission methods will improve overall ability, performance and versatility of 600 communicating to 700.

Terminal 600 transmits signal 670. Signal 670 includes a wake-up segment 662 for waking up device 700, which is typically in sleeping mode to allow for the intermittent nature of transmission 660. Signal 670 also includes a segment for UMCID 612, a segment for tuned-to frequency 612 and radio receiver ID segment 614. Although terminal 600 employs amplitude modulation, other methods may be employed.

In the cases when a TV is close-caption enabled, that information can be transmitted, via ultrasound in a protocol intended for device 700 to receive and capture. Such information may be used in place of actual recording of audio/video signal for identification purpose with the benefit of saving bandwidth and transmission time.

In FIG. 6, when antenna/sensor 720 receives signal 660 from the radio/TV receiver, the resulting signal is then fed into signal pre-processing module 722 for correction and amplification. The output from module 722 is sent to decoder 724 to be written to handset state register 728 by handset state writer 726. Handset state register 728 takes input, including current time and handset location information, from handset internal state memory 741, and even audio signal 717 if desired, as well as handset built-in radio tuned to frequency data 713 in the case when a radio is integrated into a cell phone or pager.

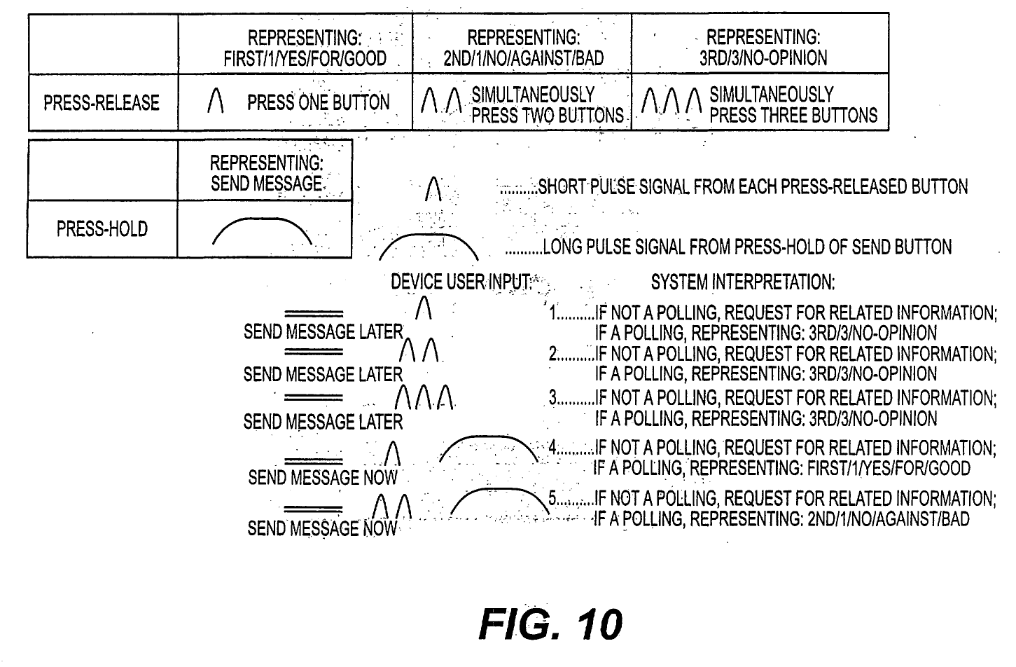

Device 700 may generate a multi-value code in response to the user's actuation of a single button 712, as shown in FIG. 8. Device 706 may also generate a code in response to the user's actuation of multiple buttons, such as button 712 in combination with button 714. More specifically, referring to FIG. 10, a user has the option of sending a response message at the time of selection or sending the message at a later time. The selection inputs are short pulses when the user releases a button immediately after pressing. When one button is press-released, it represents first/1/yes/for/good, etc; when two buttons are press-released, the input represents second/2/no/against/bad, etc; and three press-release's stand for third/3/no-opinion/no-opinion/so-so, etc. If one or all buttons are press-held for duration longer than a pre-set time period, the device will send a message including all selections stored in the device.

Therefore, when input 711 from buttons in short pulses representing selections, handset state data register 728 creates an entry including all the state data at the moment of input 711. The register 728 holds the history log of all state data from all sources corresponding to the moment at which each input from 711 is entered. When input 715 from send button in a long pulse representing send command, handset state data sampler 730 requests a data transfer action from register 728 and handset stored info module 731.

Data in 731 includes information stored by the device manufacturer and those provided by the user and updateable remotely via radio transmission from a central office of the wireless service provider. Data sampled by 730 are then complied into an email in response message generator 746. When activated to send the message, through the handset's own message transmitter 748, single or multiple messages 760 are transmitted via wireless network connection 750 to WISBRA 10.

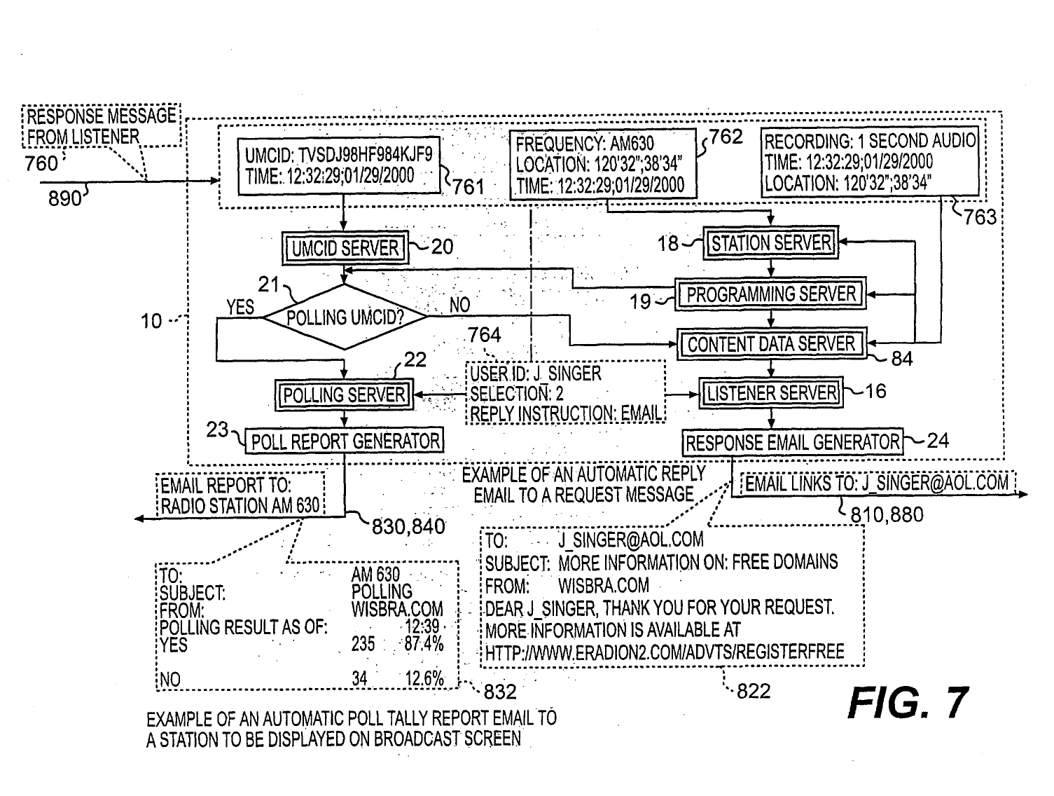

Referring to FIG. 7, through Internet connection 890, the received message 760 is reassembled into four parts: UMCID and time 761; frequency, location and time 762; recording, time and location 763. Redundant information from UMCID, frequency and recording is purposely included here for illustration of how, when only some information present, the response is processed by WISBRA 10. Such information redundancy is typically desired for better quality of response message and versatility for processing. It is possible, however, the limitation of bandwidth may initially limit the use of actual recording.

If all information is present, message 761 will be given first priority for processing in UMCID server 20, as it is data-efficient and containing all information to determine the audience's interest. UMCID server 20 will retrieve all the information related to UMCID is 761 and create a data pack to pass on to logic module 21 to decide where the data pack will be forwarded.

There are at least three types of processing outcome to a response: To provide a reply message including links or info relative to response message; to use the response data to generate a report and email back the media company as the illustrative example “Polling”; to forward part or all information from a response to another system, which can be “bidding”, “voting”, “rating”, etc.

As described earlier, if an UMCID indicates “polling” response, the information output from UMCID server will be send to Polling server 22, where User ID/Selection/Reply information 764 is combined before sending to Poll report generator 23. Example of a polling result report 832 is emailed to the polling station (AM630, for instance) at a specific cut off time. Similarly, if the message from audience is in response to a media session requesting “bidding”, “voting”, “rating”, etc. from audience, Poll server 22 and polling report generator 23 will be respective “bidding”, “voting”, “rating”, etc servers and report generators.

Polling can be conducted for situations when only Information of frequency, location and time 762 is available to Station server 18 and programming server 19 to determine the station and program to which the audience responded. If a program is found to be one that requested audience's opinions and aired time matches the audience response time, all resulting information from processing in server 18 and 19 is send to Polling server 22, whereon a report is generated and emailed as above described.

Polling may also be conducted for situations when only Information of recording, location and time 763 is available to Station server 18, programming server 19 and content data server 84 to determine the station and program to which the audience responded. This process is not as efficient as two previous steps as the content data server will run an actual comparison of recording to all program segment aired at the moment response message was created by the audience. If a program is found to be one that requested audience's opinions and aired time matches the audience response time, all resulting information from processing in server 18, 19 and 20 is send to Polling server 22, whereon a report is generated and emailed as above described.

If the UMCID indicates an information request by the audience, output from UMCID 20 or combined output from station server 18, programming server 19 and content data server 84 will be read in by listener server 16 along with user ID, selection and reply instruction 764 for processing. Including pertinent link or detail addressing the audience request, response email generator 24 will then compile an email 822, which will be sent to requesting audience following reply instruction from the particular requester.

It is advantageous for radio stations to have the ability to get listeners' instant feedback. System 2000 enables a listener to send a message to a station in real time via WISBRA 10 by pressing one button 712 in device 700. Such capability enables radio listeners to vote on polls, bid on offers, interact with a program or announcer simultaneously, anywhere, anytime, without having to call or write-in. This responding ability also minimizes or eliminates common bottlenecking for listener call-ins or the time delay for people writing in.

Media companies can determine audience information quickly and accurately. Such service, when provided to radio/TV stations, greatly improves the radio/TV broadcasting effectiveness as a media. Further, such ability for easy, instant direct response to a broadcast will significantly increase the value of radio/TV airtime, which in turn, increases profit and revenue of electronic media industry.

Methods for communicating between terminal 600 and device 700 will now be described in more detail.

A first preferred way for communication between 600 and 700 is using local oscillating frequency from listener's radio set. It is known that when a particular station is tuned to a radio set, the radio/TV set's internal oscillator generates a electromagnetic signal at a particular frequency. And such frequency can be correlated to the broadcasting frequency of the tuned-to station. Using this principle, device 700 is equipped with a radio frequency receiver that registers the frequency of a radio/TV broadcast. The registered frequency generates a piece of data that dynamically changes as the listener changes radio station or getting close to an operating radio unit tuned to a station. The above-mentioned piece of data, as explained later in “Message” of this section, will be included in the message send to WISBRA 10 and is compared with the frequencies of stations in a geological area, of which WISBRA hosts information application service. The listener's actual location information can also be obtained from wireless providers or GPS output. Such method is preferred at present time due to the fact that almost all existing radio, TV and other electronic media terminals are not compatible for advanced features described in the exemplary system.

Another preferred way of communicating information to 700 is to include UMCID signal in the broadcast and have 600 re-broadcast such UMCID with other desired information to its immediate vicinity using short range wireless communication technologies like Bluetooth, Smart Dust, Portolan Project or Bluesky. 600 is equipped to extrapolate UMCID and prepare the signals for short-range transmit. The device 700 is equipped to recognize, capture and translate the signal into a useful data piece as previously described. This method is actively relaying the information to the vicinity. Therefore it is possible to implement into all forms of electronic media terminals and is preferred over the method described in the following paragraph for future applications. This method is preferred for second phase implementation of the exemplary system for two reasons: it take time for the market to have enough device to be economical; it is a more advanced mode of the exemplary system offering higher data rate and interactivity.

A third way of communicating information to 700 is to modify radio sets to produce a non-intrusive signal, in ultrasound and/or Infrared, reflecting the radio/TV unit's actual tuned-to frequency, which is readily available for displaying channels or stations to the users. Once captured by device 700, equipped to receive such signals, and sent to WISBRA 10, such data piece will provide information for identifying ratio stations a user of device 700 listened to.

Another way of capturing information for radio station identification is to use Ultrasound or Infrared to transmit UMCID into the immediate surroundings simultaneously with regular audio/text/video program by 600. Device 700 is equipped to receive such information. One advantage for this arrangement is its simplicity. Ultrasound and Infrared cannot go through walls. Therefore such arrangement does not need logic for determining who was in the room vs. next door as required by radio wave transmission such as Bluetooth™.

A fifth way of capturing information for radio station identification is to record the actual audio signal from the radio unit off the radio station actual broadcast. The actual recording is sent to WISBRA 10 along with time and location as described before. The recording then will be compared with the digitized audio from all stations in the listener's geological area, at the time of sending the message. Using fuzzy logic and background noise processing, the match will automatically identify the station and the program/advertisement of interest to the requester.

A sixth way of identifying UMCID is to embed the UMCID in audio signal with a special coding technique that does not affect the audio quality perceived by listeners. In this case, the 640 is the same as 608

One may also use a combination of two or more ways described above to facilitate communications between media terminals and the mobile device. Such arrangement can yield the more information allowing for more accurate data communication.

FIG. 6 is a generic embodiment of the invention with IR/acoustic/RF, and FIG. 8 is specifically with passive detection of RF emission of radio receivers corresponding to local osculating frequencies.

FIG. 8 details the first method preferred embodiment of the mobile device using passive communication mode, when oscillating signal 661 from the radio/TV receiver is received by antenna 720, the resulting signal is then feed into signal pre-processing module 721 to filter out unwanted signals and to provide amplification. The output from 721 is sent to Signal Frequency/strength analyzer 723 to identify the frequency with the most signal strength. The result from 723 is feed into a dynamic frequency data generator 725 for creating digital data useful for Frequency State Data writer 726 to input into Device State Data register 728. Handset state register 728 takes input, including current time and handset location information, from handset internal state memory 741, and even audio signal 717 if desired as well as handset built-in radio tuned to frequency data 713 in the case when a radio is integrated into a cell phone or pager. The register 728 holds a history log of state changes from all input sources. Such log creation can be programmed either automatically at a pre-set time interval or when it received an input representing Selection Button Activation 711.

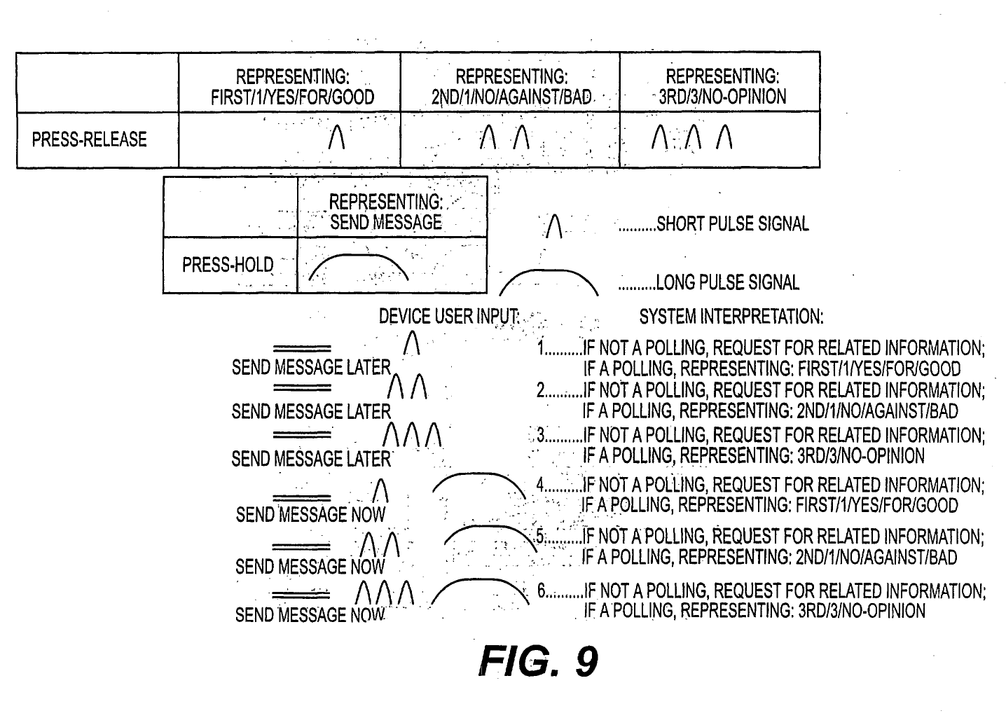

FIG. 9 shows logic in button decode module 802, allowing a single button 712 to be used to indicate for both selection and transmission. Logic in module 802 detects two types of button activation: press-release, generating a pulse signal with second half immediately follow the first half; and press-hold, generating a pulse signal with second half far apart from the first half. Button 712 generates a DC level for the time that user 74 presses down on button 712. Logic 802 measures the length of time of the level change, with a sustained level of less than one second being deemed press-release and a duration of greater than one second being deemed press-hold. Logic 802 generates a code equal to 1 when the user does a single press-release of button 712, generates a 2 when the user generates two sequential press-releases of button 712, and generates a 3 when the user actuates button 712 to produce three sequential press-releases. As shown in FIG. 9, codes 1, 2, and 3 cause device 700 to save the codes for sending at a later time, and an electronic mail message for example.

When logic 802 detects a press-release followed by a press-hold, logic 802 generates a code equal to four, when logic 802 detects two press-releases followed by a press-hold, logic 802 generates a code equal to 5 etc.

The right part of FIG. 9 indicates how system 2000 may interpret the codes generated by logic 802, which are subsequently combined with a signal from decoder 804, and transmitted by transmitter 11.

FIG. 10 shows an alternate scheme wherein button decoder logic 802 is responsive to signals from button 710 and 714, as well as button 712. Pushing one button 712 generates a single press-release, causing decoder logic 802 to generate a 1. Actuating buttons 712 and 714 simultaneously is equivalent to two press-releases, causing button decoder logic 802 to generate a 2. Actuating all three button simultaneously is equivalent to three press-releases of a single button, causing button decoder logic 802 to generate a 3. Press-release is used to indicate for selection, for example, one press-release stands for first/1/yes/for/good, etc; while two consecutive press-release's stand for second/2/no/against/bad, etc; three consecutive press-release's stand for third/3/no-opinion/no-opinion/so-so, etc. The practical time allowed for three consecutive pressrelease's is about one second. So the device can be programmed to detect pulses for a specified duration, as an example 1.2 second.

The press-hold can be used to initiate transmission. Thus when the Button Activation module 719 detects a first half pulse and fails to detect the second half of the pulse for a specified duration, as an example, 1 second, it sends a command 715 to device State Data Sampler 730.

Upon detecting an input from user button selection 715, handset state data sampler 730 requests a data transfer from register 728 and stored device information 731, which is provided by the user and updateable remotely via radio transmission from a central office of the wireless service provider. Data sampled by 730 are then complied into an email in response message generator 746. When activated to send the message, through the built-in message transmitter 748, single or multiple messages 760 are transmitted via wireless network connection 750 to WISBRA 10.

If there is no radio station tuned to at the time of button activation, the last message will not have information for station identification. WISBRA 10 will ignore such data register log entries during message processing.

In summary, system 2000 is for creating and operating an integrated electronic media environment, especially for TV and radio, to enable close to real-time automatic media selling and buying, automatic content indexing and retrieval, automatic recognition of an operating electronic media receiver closest to a responding individual in a multi-receiver environment, and enabling instant wireless messaging in response to a broadcast or a general media session from anywhere and at anytime. System 2000 provides electronic media receivers for exposing the audience to a media session and transmitting information related to the media session at a first location, a wireless handheld device for receiving information related to the media session from the electronic media receiver and for automatic compiling and transmitting one or more messages corresponding to user's response to the media session at a first location, a computer with web browser and internet service or a internet ready device located at a second location remote or close to first location, a web-based electronic media business application computer system for on-line media selling and buying, universal media content identification (UMCID) generating and management, audience service, station service, content management and security management at a third location remote to the first and second location, a computer with web browser and internet service located at a on-line media buyer's location, a computer functionally similar to the buyer's at broadcast programming personnel's location, a computer functionally similar to the buyer's at program producer's location and a computer functionally similar to the buyer's at a disk jockey's location. System 2000 allows people to create an on-line advertisement over the internet by the on-line media buyer, the web-based electronic media business application computer system generating a unique UMCID and attaching to that content created, reserve and marling one or more spots as sold in future play-list through browser in the media buyer's computer and updating such information in real time in the web-based electronic media business application computer system master database, entering text content or importing existing digital content linked to the sold spots through the media buyer's computer or similar computer into the master database of the web-based electronic media business application computer system, dynamically feed time-driven spot and associated content information from the master database from the computer system into the computers at program producer's and disk jockey's locations over the internet, broadcasting the content from programming transmitter programming in audio, video or browser displayable format to one or more electronic media receivers at the first location, receive the content at the receiver, generating humanly perceptible audio, video or browser display output and transmitting a humanly imperceptible signal with UMCID and other desirable information into the environment of the first location.

Device 700 registers a user input by the device upon activation of an interface on the device, generates a dynamic log of the signal, user input and time of the input temporarily stored in the wireless handheld device, automatically compiles an email message including the log and other desirable information at the device, and automatically transmits the message via wireless network to the electronic media business application system upon user activation of a send input interface in the device.

System 2000 then receives the message at electronic media business application system, processes the message at the system according to UMCID in the messages to (a) reply to a response message include links on the internet to information satisfying user's request; or (b) forward some or all the information in the message to another system or specific locations; or (c) compose and post a report on information in the messages for publishing and access over the internet by authorized users, and returns, through internet per instruction in the message or UMCID, the processing results, to the computer at the second location or an internet ready device at the second location or to the device at the first location; to a computer to another system or specific locations; to one or more specific computers within the computer system or at a location remote to the system.

Terminal 600 may be a TV, CD player, tape player, MP3 player or a computer or any other device for electronically carrying and render information in forms that are humanly perceptible.

Terminal 600 may include circuitry to read and extract the UMCID information sent with regular content to web browsers; generate infrared light as active transmission media for human imperceptible signal; generate radio wave as active transmission media for human imperceptible signal.

Thus the preferred embodiments of the exemplary system provide an apparatus and method for prompt wireless instant messaging in response to radio or tv broadcasting and other electronic media session.

Though the illustrated system shows terminal 600 being a housing and terminal 700 being a separate housing, the functions of terminal 600 and device 700 may be combined into a device with a single portable housing such as a small radio or a combination radio cellular phone handset.

Although signal combiner 806 generates a composite signal by combining the output of decoder 804 in a respective field different from fields occupied by the output of decoder logic 802, these two types of signals may be combined in a more integrated way, to occupy a single field with a field value derived from the combination of the output of decoder logic 802 and the output of decoder 804.

Although the illustrated system includes a device 700 that transmits a combined system in an electronic mail message sent over a voice channel of a telephone network, the invention may be practiced with other modes of sending the combined signal. For example, an alternative device 700 may send the combined signal using some type of Short Message Service, sharing the spectrum of a control channel in a wireless cellular telephone system.

Additional advantages and modifications will readily occur to those skilled in the art. The invention in its broader aspects is therefore not limited to the specific details, representative apparatus, and illustrative examples shown and described. Accordingly, departures may be made from such details without departing from the spirit or the scope of Applicants' general inventive concept. The invention is defined in the following claims. In general, the words “first,” “second,” etc., employed in the claims do not necessarily denote an order.

What is claimed is:

1. A method for a system having a transmitter that broadcasts a first signal, the method comprising:
receiving the first signal;
decoding the first signal into a second signal, the second signal being human perceptible;
decoding the first signal into a third signal, the third signal being digital;
receiving an input from a user, after the decoding steps;
generating a fourth signal, responsive to the input;
generating a fifth signal by appending the fourth signal to the third signal; and
sending the fifth signal.

2. The method of claim 1 wherein sending includes sending the fifth signal into a telephone network.

3. The method of claim 2 wherein sending further includes sending into a voice channel of the telephone network.

4. The method of claim 1 wherein sending includes generating an electronic mail message.

5. The method of claim 1 wherein the input has greater than 2 values.

6. The method of claim 1 wherein the third signal includes an identification of an originator of a content of the first signal.

7. The method of claim 1 wherein the third signal includes an identification of an agency representing a buyer of an advertisement in the first signal.

8. The method of claim 1 wherein the third signal includes an identification of a broadcasting network carrying the first signal.

9. The method of claim 1 wherein the third signal includes an identification of a station or channel carrying the first.

10. The method of claim 1 further including
receiving fifth signals from a plurality of users;
processing the received fifth signals to generate a composite signal.

11. The method of claim 10 wherein the second signal includes an invitation to respond to a survey, and the composite signal includes a result of the survey.

12. The method of claim 11 wherein the third signal includes an identifier corresponding to the survey.

13. The method of claim 12 wherein the identifier includes a number identifying a question in the survey.

14. The method of claim 1 further including periodically inserting the third signal into the first signal.

15. A processing system for a system having a transmitter that broadcasts a first signal, the processing system comprising:
a receiver that receives the first signal;
a decoder that decodes the first signal into a second signal, the second signal being human perceptible, and decodes the first signal into a third signal, the third signal being digital;
a user interface that can generate 2 values in response to manipulation by the user;
a signal generator that generates a fourth signal, responsive to the input, and a fifth signal by appending the fourth signal to the third signal; and
a transmitter that transmits the fifth signal.

16. The processing system of claim 15 wherein the transmitter includes an interface into a telephone network.

17. The processing system of claim 15 wherein the transmitter includes a telephone.

18. The processing system of claim 15 further including software that generates an electronic mail message.

19. The processing system of claim 15 wherein the input has greater than 2 values.

20. The processing system of claim 15 wherein the third signal includes an identification of an originator of a content of the first signal.

21. The processing system of claim 15 wherein the third signal includes an identification of an agency representing a buyer of an advertisement in the first signal.

22. The processing system of claim 15 wherein the third signal includes an identification of a broadcasting network carrying the first signal.

23. The processing system of claim 15 wherein the third signal includes an identification of a station or channel carrying the first.

24. The processing system of claim 1 further including
a network node that receives fifth signals from a plurality of users, the network node including a processor that processes the received fifth signals to generate a composite signal.

25. The processing system of claim 24 wherein the second signal includes an invitation to respond to a survey, and the composite signal includes a result of the survey.

26. The processing system of claim 25 wherein the third signal includes an identifier corresponding to the survey.

27. The processing system of claim 26 wherein the identifier includes a number identifying a question in the survey.

28. The processing system of claim 15 further including periodically inserting the third signal into the first signal.
